(19) United States
(12) Patent Application Publication
(10) Pub. No.: US 2008/0173428 A1
(43) Pub. Date: Jul. 24, 2008

(54) AUTOMATIC TRANSMISSION FLUID COOLER AND ASSOCIATED METHOD

(75) Inventors: George MOSER, Brighton, MI (US); Gordon SOMMER, Plymouth, MI (US); Adam OSTAPOWICZ, Westland, MI (US)

Correspondence Address: HARNESS, DICKEY & PIERCE, P.L.C., P.O. BOX 828, BLOOMFIELD HILLS, MI, 48303, US

(73) Assignee: EDC AUTOMOTIVE, LLC, Auburn Hills, MI (US)

(21) Appl. No.: 12/017,428

(22) Filed: Jan. 22, 2008

Related U.S. Application Data
(63) Continuation of application No. 11/140,670, filed on May 27, 2005, now abandoned.
Application No. 11/140,670 is a continuation-in-part of application No. 10/404,015, filed on Mar. 31, 2003, now abandoned.

(51) Int. Cl. F28F 13/12; F28D 15/00; B23P 15/26

(52) U.S. Cl. 165/104.19; 165/109.1; 29/890.035

(57) ABSTRACT

A transmission fluid cooler for cooling the automatic transmission fluid of a motor vehicle equipped with an automatic transmission, and associated method. The transmission fluid cooler can include a fluid inlet tank, a fluid outlet tank, and a plurality of extruded aluminum heat transfer tubes connecting the inlet tank to the outlet tank. Each tube can include first and second substantially flat sidewalls, a plurality of internal webs extending between the first and second sidewalls, and a plurality of dimples and convolutions to cause turbulation and stirring of the transmission fluid in order to increase heat transfer.

### CROSS-REFERENCE TO RELATED APPLICATIONS

This application is a continuation of U.S. patent application Ser. No. 11/140,670 filed on 27 May 2005, which is a continuation-in-part of U.S. patent application Ser. No. 10/404,015 filed on 31 Mar. 2004 which claims the benefit of U.S. Provisional Application No. 60/375,920 filed on 25 Apr. 2002. The disclosures of these applications are incorporated by reference as if fully set forth herein.

### TECHNICAL FIELD

The present teachings generally relate to cooling of transmission fluid used in the automatic transmission of a motor vehicle and associated methods.

### INTRODUCTION

In the automotive industry it is necessary to cool the fluid used in automatic transmissions. The automotive transmission fluid (ATF) reaches high temperatures in the operation of the transmission. These high temperatures need to be reduced to avoid breakdown of the fluid. A device called a transmission fluid cooler is conventionally used for that purpose.

With reference to the simplified prior art view of FIG. 1, a typical transmission fluid cooler 3 is illustrated in an automotive application. The exemplary application is shown to generally include an engine 4 and a transmission 5. The transmission fluid cooler 3 is typically located inside one of the tanks 2 of a radiator 1. The coolant inside the tanks 2 is used as the cooling medium for the fluid cooler 3. This is possible despite the fact that the coolant itself is relatively hot, because the transmission fluid temperature is substantially higher. The temperature differential between the coolant in the radiator tank 2 and the transmission fluid in the transmission fluid cooler 3 is used to cool the transmission fluid. The transmission fluid circulates through hydraulic lines 6 between the transmission 5 and the transmission fluid cooler 3. The transmission fluid gets cooled in the transmission fluid cooler 3.

FIG. 2 illustrates one typical transmission fluid cooler 3 in further detail. The transmission fluid cooler 3 is located inside the tank 2 of radiator 1. This type of transmission fluid cooler, which consists of concentric brass tubes between which the fluid flows, is typically made by brazing, a high temperature process that requires expensive brazing equipment and complex process control. The result is a relatively expensive and heavy fluid cooler. FIG. 2A shows the cross section of the fluid cooler.

FIG. 3 shows a more modern transmission fluid cooler 3′. The fluid cooler 3′ is again located inside the tank 2 of radiator 1. This type of fluid cooler 3′ is called a plate cooler, because it basically consists of several flat plates inside which the fluid flows. Plate fluid coolers are typically made using aluminum strips which are joined together along their perimeter in a brazing process. The use of flat plates leads to a better heat exchange performance than for a concentric tube cooler, but the result is still a relatively expensive and heavy fluid cooler. The very large number and length of brazed joints creates many potential failure modes (leaks), which has a potential negative impact on the reliability of this fluid cooler.

FIG. 4 shows an engine oil cooler 7 that can be used in addition to the previously shown transmission fluid cooler 3. Some vehicles require both an engine oil cooler and a transmission fluid cooler. Virtually every vehicle with an automatic transmission requires a transmission fluid cooler, and many high powered or high rpm engines require also an engine oil cooler. Typically the engine cooler and the transmission fluid cooler are on two separate, independent cooling circuits. The engine oil circulating through the engine oil cooler 7 is typically cooled by placing the oil cooler 7 in a housing that contains coolant. Another possibility (not shown here) is to place the engine oil cooler in the second radiator tank (the first one is already occupied by the transmission fluid cooler).

While known transmission fluid coolers have proven to be suitable for their intended purposes, a need remains in the pertinent art for a lightweight, low cost, highly reliable transmission fluid cooler with highly efficient heat transfer characteristics.

### SUMMARY

The present teachings provide a transmission fluid cooler for cooling a transmission fluid of a motor vehicle equipped with an automatic transmission. The transmission fluid cooler can include a fluid inlet tank, a fluid outlet tank, and a plurality of heat transfer tubes connecting the inlet tank to the outlet tank. Each tube can include first and second substantially flat sidewalls; a plurality of internal webs extending between the first and second sidewalls to provide mechanical strength to each tube and allow it to withstand the internal fluid pressure it will be subjected to; a plurality of dimples to disrupt, stir and turbulate the transmission fluid flowing inside each tube; and a plurality of convolutions intended to turbulate the fluid flowing inside each tube to increase heat transfer.

The present teachings also provide a method of cooling an automatic transmission fluid of a motor vehicle. The method includes providing a transmission fluid cooler having a fluid inlet tank, a fluid outlet tank and a plurality of heat transfer tubes connecting the inlet and outlet tanks. Each tube comprising first and second substantially flat sidewalls. Internal webs extending between the sidewalls and a plurality of first dimples formed on one of the sidewalls. Each of the first dimples are formed over one of the webs.

The method additionally includes immersing at least the plurality of aluminum extruded tubes in a cooling liquid.

The method further includes routing the automatic transmission fluid through the plurality of aluminum extended tubes.

The present teachings also provide a method for making a transmission fluid cooler for cooling the transmission fluid in a motor vehicle equipped with an automatic transmission. The method includes forming a plurality of tubes having first and second substantially flat sidewalls, coupling a first end of each tube to a fluid inlet tank, coupling a second end of each tube to a fluid outlet tank, forming webs between the first and second sidewalls of each tube, and forming a plurality of first dimples on the first sidewall of each tube, each first dimple formed over one of the webs.

Further areas of applicability of the present invention will become apparent from the detailed description provided hereinafter. It should be understood that the detailed description and specific examples, while indicating the embodiment of the invention, are intended for purposes of illustration only and are not intended to limit the scope of the invention.

### BRIEF DESCRIPTION OF THE DRAWINGS

The present teachings will become more fully understood from the detailed description and the accompanying drawings, wherein:

FIG. 1 is a schematic illustration of a prior art transmission fluid cooler circuit.

FIG. 2 is a view of a prior art conventional transmission fluid cooler of concentric tube design shown in partial section.

FIG. 2A is a cross-sectional view taken along the line 2A-2A.

FIG. 3 is a view of another prior art transmission fluid cooler of plate design shown in partial section.

FIG. 4 is a schematic illustration of prior art engine oil fluid cooler and transmission fluid cooler circuits.

FIG. 5 is a top view of a transmission fluid cooler according to the present teachings.

FIG. 6 is a side view of the transmission fluid cooler of FIG. 5.

FIG. 6A is a cross-sectional view taken along the line 6A-6A of the heat exchange tube.

FIG. 7 is a top view of a transmission fluid cooler according to the present teachings.

FIG. 8 is a top view of a transmission fluid cooler according to the present teachings.

FIG. 9 is a top view of a transmission fluid cooler according to the present teachings.

FIG. 10A is a cross-sectional view of a heat transfer tube of a transmission fluid cooler according to the present teachings.

FIG. 10B is a cross-sectional view of the tube of FIG. 10A taken along a line perpendicular to the line of the FIG. 10A cross-section.

FIG. 11A is a cross-sectional view of a tube of a transmission fluid cooler according to the present teachings.

FIG. 11B is a cross-sectional view of the tube of FIG. 11A taken along the line perpendicular to the line of the FIG. 11A cross-section.

FIG. 12A is a cross-sectional view of a tube of a transmission fluid cooler according to the present teachings.

FIG. 12B is a cross-sectional view of the tube of FIG. 12A taken along the line perpendicular to the line of the FIG. 12A cross-section.

FIG. 13 is a side view of a portion of a tube of a transmission fluid cooler according to the present teachings.

FIG. 13A is a cross-sectional view taken along the line 13A-13A.

FIG. 14 is a top view of a transmission fluid cooler according to the present teachings.

FIG. 15 is a side view of the transmission fluid cooler of FIG. 14.

FIG. 16 is a top view of a transmission fluid cooler according to the present teachings.

FIG. 17 is a side view of the transmission fluid cooler of FIG. 16.

FIG. 18 is a side view of a transmission fluid cooler according to the present teachings.

FIG. 19 is a top view of the transmission fluid cooler of FIG. 18.

FIG. 20 is a cross-sectional view taken along the line 20-20 of FIG. 18.

FIG. 21 is a cross-sectional view taken along the line 21-21 of FIG. 18.

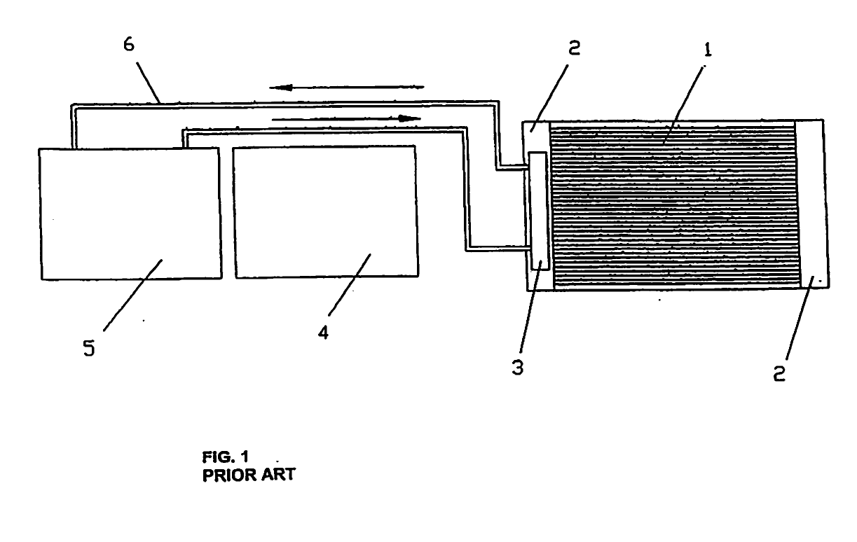

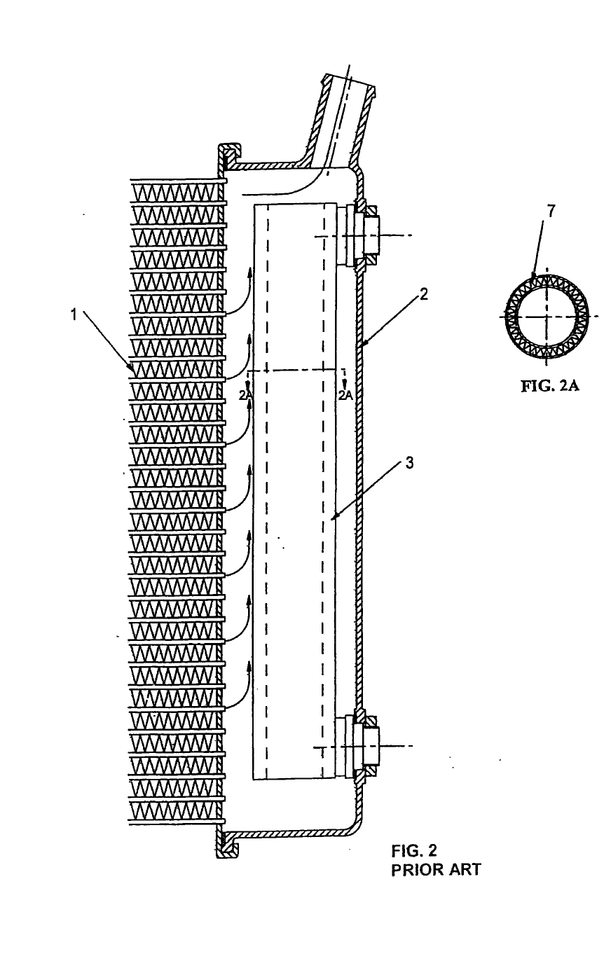

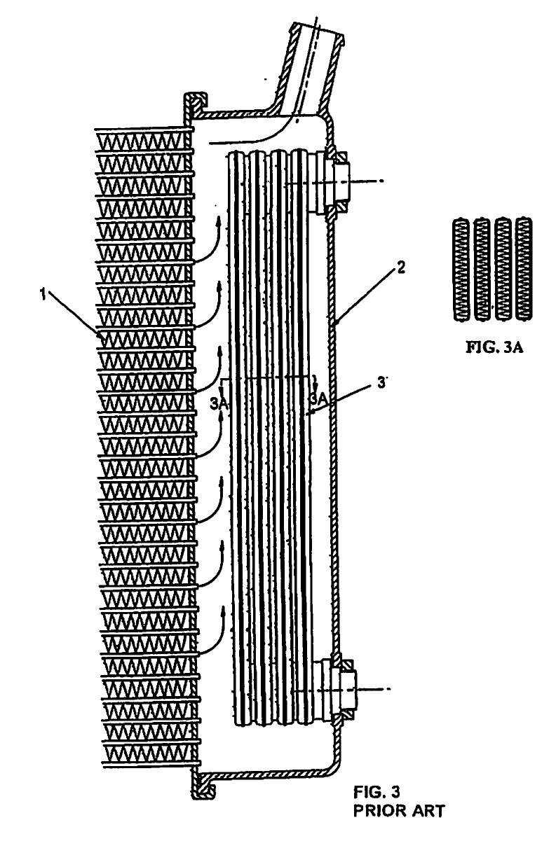

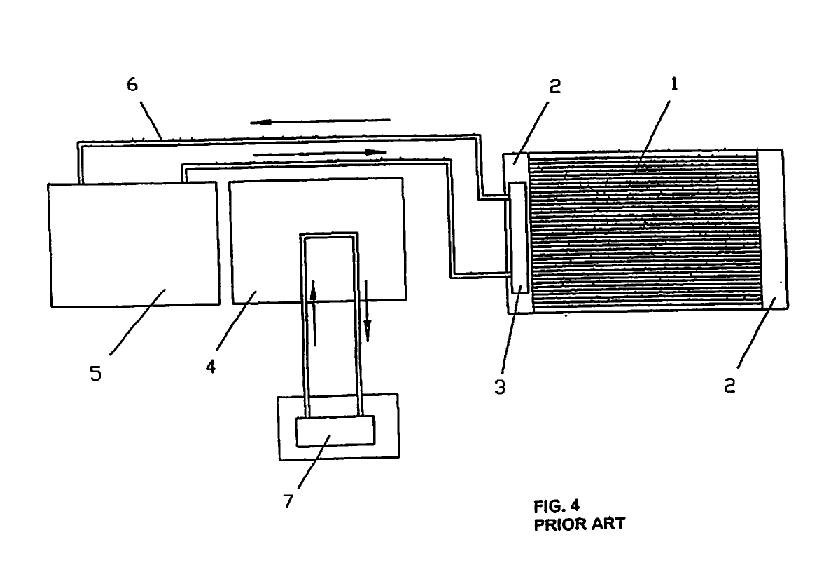

### DESCRIPTION OF VARIOUS ASPECTS

The following description of various aspects of the present teachings is merely exemplary in nature and is in no way intended to limit the invention, its application, or uses.

Referring to FIG. 5, the transmission fluid cooler 10 is shown to generally include first and second end tanks 12 and 14. The end tanks 12 and 14 can be round or circular in shape. The end tanks 12 and 14 can be connected by a plurality of heat transfer tubes 16. In the exemplary illustration of FIG. 5, the transmission fluid cooler 10 is shown to include five such tubes 16, although any number of tubes 16 can be used. The tubes 16 may be brazed to the end tanks 12 and 14. The first end tank 12 defines a first port 18 as the inlet of oil to be cooled and the second end tank 14 defines a second port 20 as the outlet. Typically, the ends of the tanks 12, 14 can threaded or equipped with some type of connector that allows the connection to the hydraulic lines leading the oil. The complete transmission fluid cooler 10 can be immersed in a cooling medium, such as radiator-coolant, typically a mixture of 50% water and 50% glycol. The heat of the oil is transferred through the tube walls to the cooling medium, so that the temperature of the oil leaving the transmission fluid cooler 10 is significantly lower than the temperature of the oil flowing into the transmission fluid cooler 10.

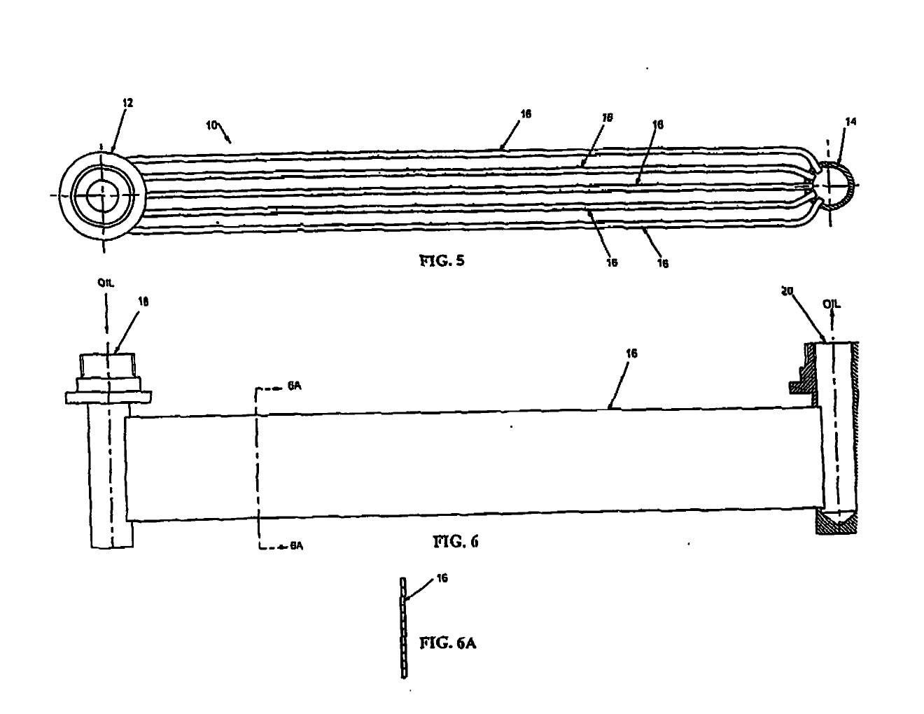

FIG. 7 illustrates another exemplary transmission fluid cooler 30 that includes three tubes 16 adapted for applications, for example, in which less heat transfer is required. FIG. 8 illustrates another exemplary transmission fluid cooler 32 in which four tubes 16 are used. FIG. 9 illustrates another exemplary transmission fluid cooler 34 with six tubes 16, for applications in which greater heat transfer is desirable.

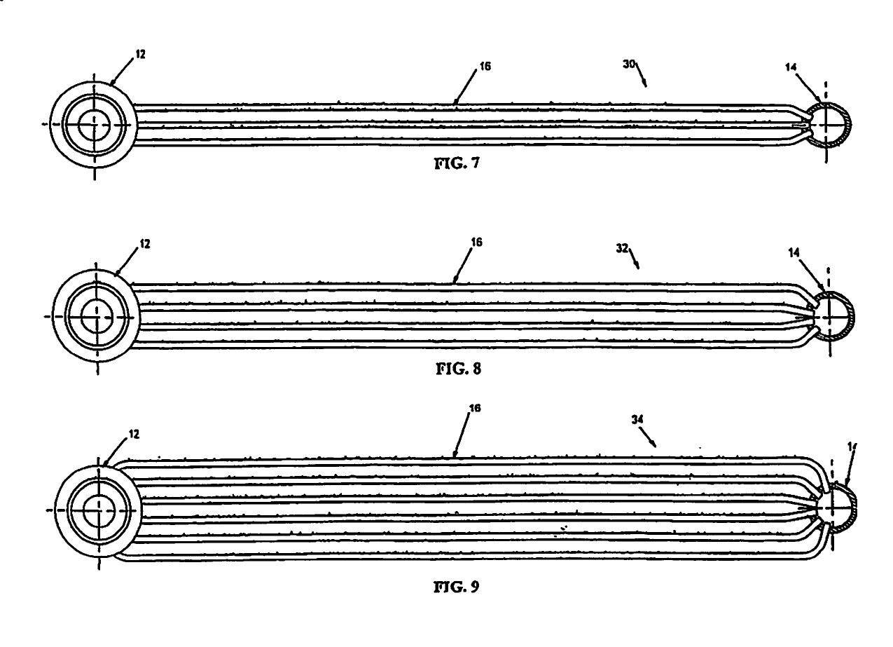

Referring to FIG. 10A, an enlarged cross-section of one of the tubes 16 is illustrated. In the exemplary aspect of FIG. 10A, the tube 16 is shown to include a pair of sidewalls 38, and internal webs 40 connecting the sidewalls 38. The internal webs 40 are incorporated to provide strength to the tube 16 to meet the requirement of a high-pressure test that the transmission fluid cooler 10 must pass for validation. FIG. 10B is a cross-sectional view of tube 16 of FIG. 10A taken along a line perpendicular to the cross-sectional line of FIG. 10A.

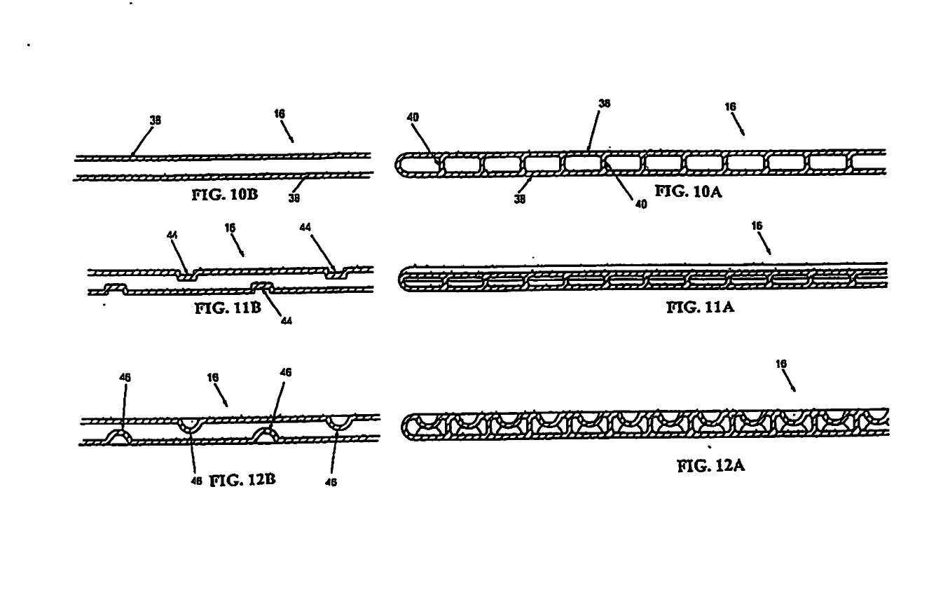

FIGS. 11A and 11B illustrate another exemplary aspect of the tubes 16 according to the present teachings. In this aspect, the tube 16 can include indentations 44 along the full width of the tube 16, alternately spaced on both sidewalls 38 of the tube 16. Turbulation of the flow through the tubes 16 occurs at each indentation 44, increasing the heat transfer.

Referring to FIGS. 12A and 12B, an exemplary tube 16 can include dimples 46 that are formed alternately on both sidewalls 38 of the tube 16 and located between the internal webs 40. The dimples 16 can be of round, circular, oval or other shapes as desired. Turbulation of the flow through the tubes 16 occurs at each dimple 46, increasing the heat transfer.

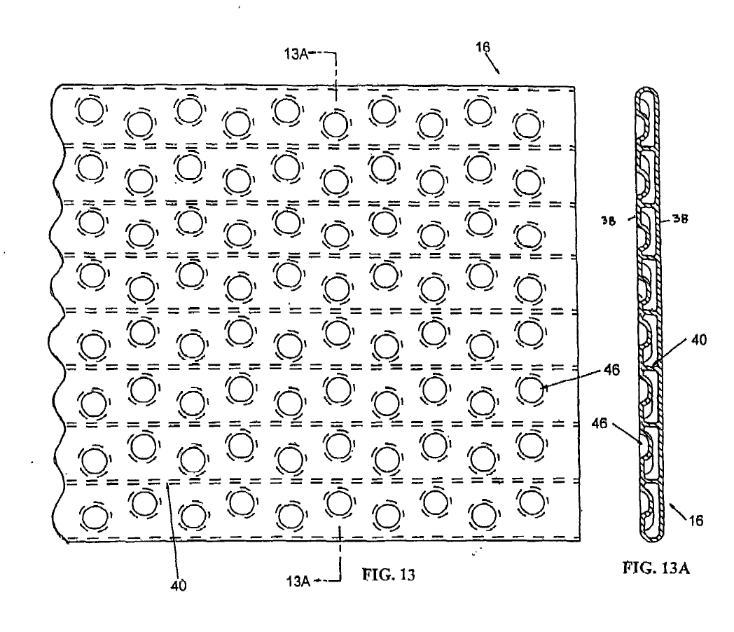

Referring to FIG. 13 and FIG. 13A, exemplary tubes 16 can include dimples 46 formed on one of the sidewalls 38 in a staggered or zigzag pattern. In the exemplary illustration of FIGS. 13 and 13A, the opposite sidewall 38 does not include any dimples 46.

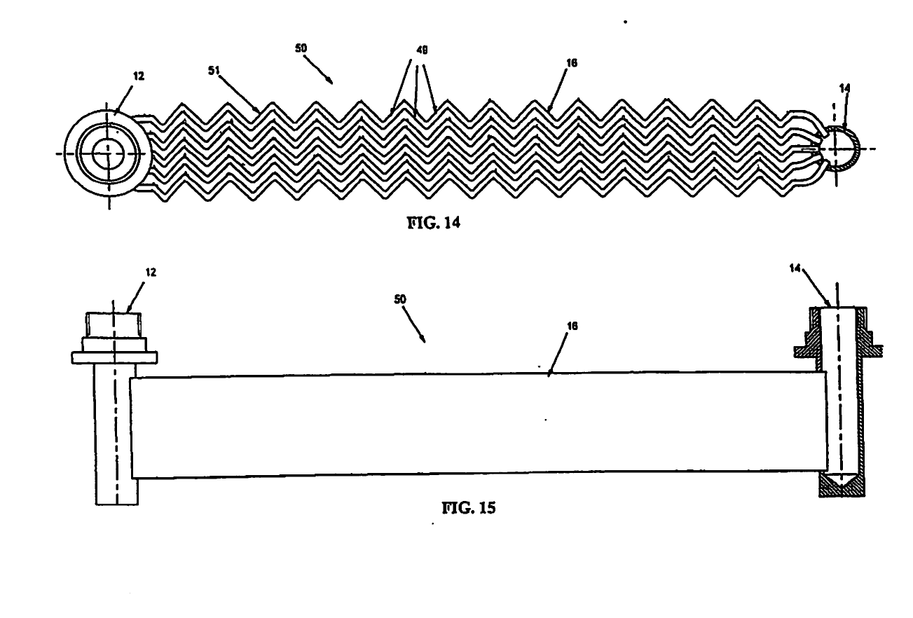

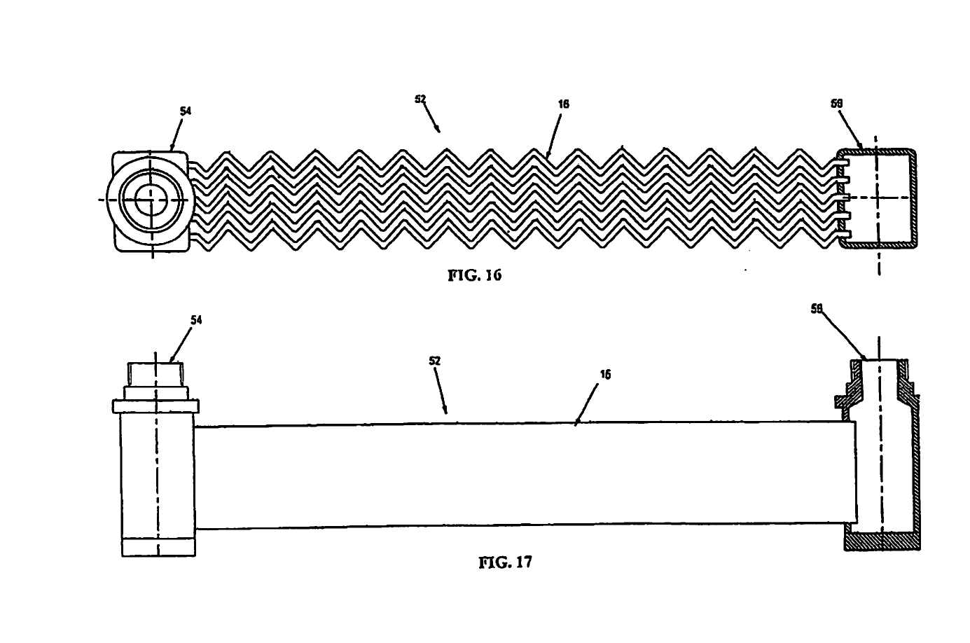

Referring to FIGS. 14 and 15, an exemplary transmission fluid cooler 50 according to the present teachings can include a plurality of tubes 16, with each tube defining a convoluted shape having convolutions 51. The multiple direction change of each tube 16 provides good turbulence for efficient heat transfer. The transmission fluid cooler 50 can also include round, rectangular or otherwise shaped end tanks 12 and 14.

With reference to FIGS. 7 and 8, another exemplary transmission fluid cooler 52 having convoluted tubes 16 can include first and second end tanks 54 and 56 that are rectangular in shape. Other shapes of end tanks 54, 56 can be used, such as oval, elliptical or of other polygonal or curved, as desired in a particular application.

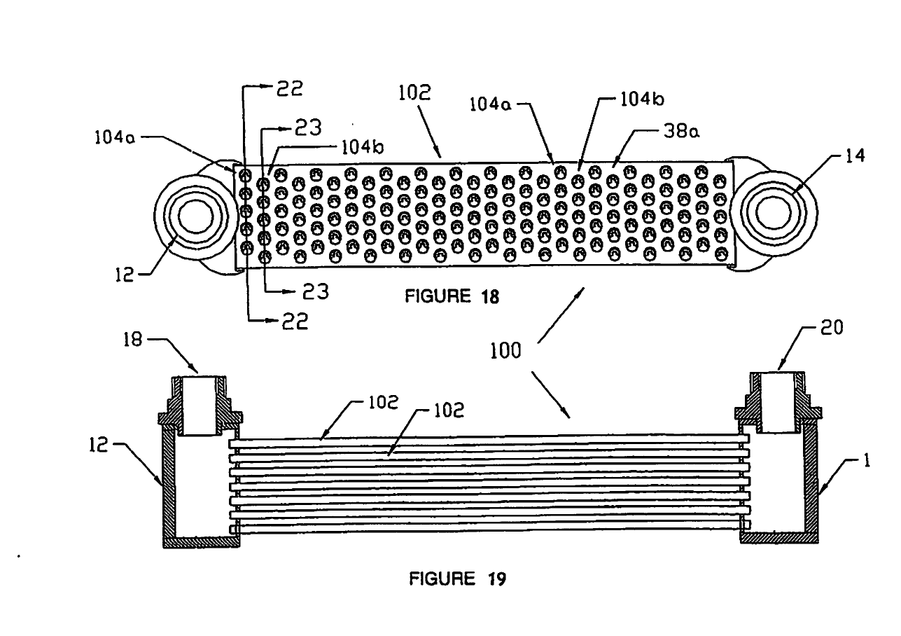

Referring to FIGS. 18-21, another aspect of a transmission fluid cooler constructed in accordance with the present teachings is illustrated and generally identified at reference character 100. The transmission fluid cooler 100 can be mounted within one of the tanks of the radiator that is used to cool the engine of the vehicle. The transmission fluid cooler 100 can generally include first and second end tanks 12 and 14. The end tanks 12 and 14 can be connected by a plurality of heat transfer tubes 102. The tubes can be extruded from aluminum. The tubes 102 can be brazed or otherwise suitably attached to the tanks 12 and 14 in a manner well-known in the art. As described above, the heat of the oil can be transferred through the tube walls to the cooling medium, so that the temperature of the oil leaving the transmission fluid cooler 100 is significantly lower than the temperature of the oil flowing into the transmission fluid cooler 100. Dimples or indents 104 can be formed on each sidewall of each heat transfer tube 102 to improve heat exchange.

The dimples 104 of the transmission fluid cooler 100 can be configured to improve the thermal capacity of the tubes 102 to meet applicable requirements. According to the present teachings, the dimples 104 can deep enough to provide adequate turbulation without tearing or fracturing the sidewalls of the tubes 102. The associated dimpling process is adapted to be repeatable and consistent and avoids variability in the cooling performance of the transmission fluid coolers 100. The dimples 104 are configured such that they do not affect the ability of the transmission fluid cooler 100 to withstand pressures of the order of 500 psi.

Referring to FIGS. 18, 20 and 21, an exemplary arrangement of dimples 104 according to the present teachings is illustrated. A plurality of first dimples 104a formed on a first sidewall 38a of the tube 102 is illustrated in solid lines. A plurality of second dimples 104b formed on a second sidewall 38b of the tube 102 is illustrated in phantom lines. The first and second dimples 104a, 104b are formed directly over alternating webs 40a, which are shortened to accommodate the depth of the dimples 104a, 104b. The dimples 104a, 104b can be formed centrally relative to the respective webs 40a, 40b. The first dimples 104a on the first sidewall 38a can be shifted relative to the second dimples 104b on the second sidewall 38b by one web, such that the webs 40a corresponding the first dimples 104a alternate with the webs 40b that support the second dimples 104b. In particular, each first dimple 104a is centered over a first web 40a and extends to two adjacent second webs 40b on each side of the first web 40a. Similarly, each second dimple 104b is centered over a second web 40b and extends to two adjacent first webs 40a on each side of the second web 40b. Forming the first and second dimples 104a, 104b directly over one of the first and second webs 40a, 40b allows the formation of much larger dimples that can extend nearly to the adjacent web on either side of the web central to the dimple without any tearing of sidewall metal. The dimples 104a, 104b can be formed very consistently because the webs 40a, 40b provide metal restraint on the punch used for the forming. The dimples 104a, 104b can be round, circular, oval, rectangular or have any other shape.

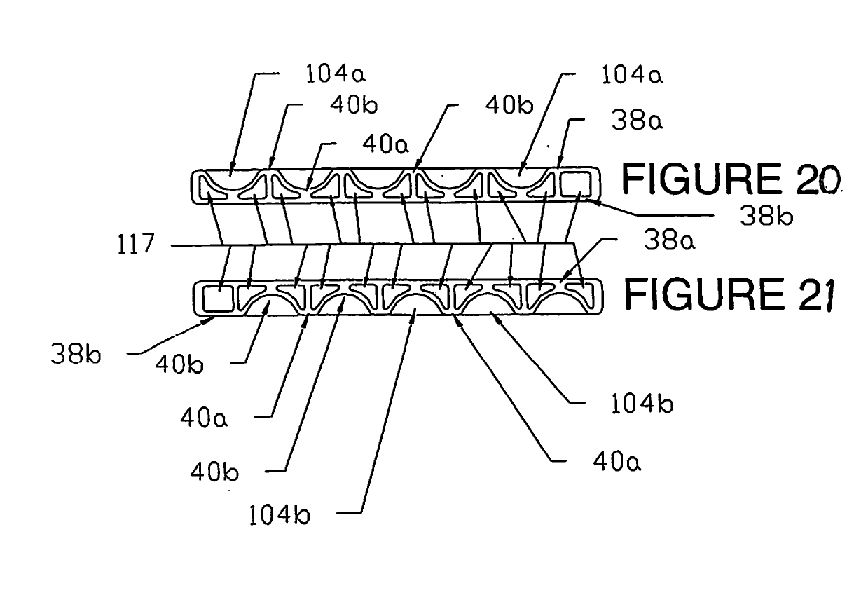

Referring to FIG. 20, two fluid flow passages 117 bounded by first and second webs 40a, 40b are formed between each of the first dimples 104a and the second sidewall 38b. Referring to FIG. 21, two fluid flow passages 117 bounded by first and second webs 40a, 40b are also formed between the second dimples 104b and the first sidewall 38a. Each fluid flow passages 117 can have a substantially triangular shape, with one side following the curve defined by the corresponding dimple 104a, 104b. The second dimples 104b can be offset transversely by one web 40b from the webs 40a that are central to first dimples 104a. The arrangement of the first and second dimples 104a, 104b defines a continuing and very frequent change in fluid flow passage position and area, and creates enough turbulence to meets the critical criteria for transmission oil coolers.

In one aspect, the cross-sectional dimensions of the heat transfer tubes 102 can be, for example, about 2.8 mm by 34 mm, and the spacing between adjacent webs 40 can be about 2.5 mm.

It will be appreciated from the above description that the present teachings provide a lightweight, low cost, highly reliable transmission fluid cooler with highly efficient heat transfer characteristics. Further, the transmission fluid cooler can increase reliability and reduces/eliminates potential failure modes, such as leaks. Extruded aluminum tubes can be used as part of the heat transfer mechanism. Extruded tubes simplify the manufacturing process, and reduce or eliminate potential failure modes (leaks), which directly impact reliability, production cost, testing cost and warranty costs. The use of extruded tubes dramatically reduces the need to join surfaces through brazing in a watertight and fluid tight manner. Since every joint in a pressurized transmission fluid cooler is always a potential failure mode, the elimination or reduction in the number of joints provides a major reliability advantage.

Further increase in the heat transfer capability of the transmission fluid cooler can be provided by modifying the extruded tubes, for instance, by bending or convoluting them in order to increase turbulence in the tubes.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A transmission fluid cooler for cooling the automatic transmission fluid in a motor vehicle by immersion of the transmission fluid cooler into a cooling liquid, the transmission fluid:
a fluid inlet tank;
a fluid outlet tank; and
a plurality of extended aluminum heat transfer tubes connecting the inlet tank to the outlet tank, wherein each tube comprises:
first and second substantially flat sidewalls;
a plurality of internal webs extending between the first and second sidewalls; and
a plurality of first dimples formed on the first sidewall, each first dimple formed over one of the webs.

2. The transmission fluid cooler of claim 1, wherein the first dimples are formed over alternate webs of the tube.

3. The transmission fluid cooler of claim 2, further comprising a plurality of second dimples formed on the second sidewall of each tube, each second dimple formed over one of the webs.

4. The transmission fluid cooler of claim 3, wherein the second dimples are offset laterally by one web relative to the first dimples.

5. The transmission fluid cooler of claim 1, wherein each first dimple is formed substantially centrally relative to the corresponding web.

6. The transmission fluid cooler of claim 4, wherein each of first and second dimples are formed substantially transmission fluid cooler centrally relative to the corresponding webs.

7. The transmission fluid cooler of claim 1, wherein each first dimple defines a pair of fluid flow passages between the first dimple and the second sidewall.

8. The transmission fluid cooler of claim 3, wherein each second dimple defines a pair of fluid flow passages between the second dimple and the first sidewall.

9. The transmission fluid cooler of claim 6, wherein the dimples have shapes selected from the group consisting of oval, square, rectangular, polygonal, circular and rounded.

10. The transmission fluid cooler of claim 1, wherein the tubes are connected to the inlet and outlet tanks by brazing.

11. The transmission fluid cooler of claim 1, further comprising cooling fins positioned between the tubes.

12. A method of cooling an automatic transmission fluid of a motor vehicle, the method comprising:
providing a transmission fluid cooler having a fluid inlet tank, a fluid outlet tank and a plurality of heat transfer tubes connecting the inlet and outlet tanks, each tube comprising first and second substantially flat sidewalls, internal webs extending between the sidewalls and a plurality of first dimples formed on one of the sidewalls, each of the first dimples formed over one of the webs;
immersing at least the plurality of aluminum extruded tubes in a cooling liquid; and
routing the automatic transmission fluid through the plurality of aluminum extended tubes.

13. The method of cooling an automatic transmission fluid of a motor vehicle of claim 12, wherein the first dimples are formed over alternate webs of the tube.

14. The method of cooling an automatic transmission fluid of a motor vehicle of claim 13, further comprising a plurality of second dimples formed on the second sidewall of each tube, each second dimple formed over one of the webs.

15. The method of cooling an automatic transmission fluid of a motor vehicle of claim 14, wherein the second dimples are offset laterally by one web relative to the first dimples.

16. A method for making a transmission fluid cooler for cooling the automatic transmission fluid in a motor vehicle by immersion of the transmission fluid cooler into a cooling liquid, the method comprising:
extruding a plurality of aluminum tubes having first and second substantially flat sidewalls;
coupling a first end of each tube to a fluid inlet tank;
coupling a second end of each tube to a fluid outlet tank;
forming webs between the first and second sidewalls of each tube;
forming a plurality of first dimples on the first sidewall of each tube, each first dimple formed over one of the webs; and
brazing the transmission fluid cooler in a brazing oven.

17. The method of claim 16, further comprising forming the first dimples over alternate webs.

18. The method of claim 17, further comprising forming a plurality of second dimples on the second sidewall of each tube over alternate webs of the tube.

19. The method of claim 18, wherein forming the second dimples comprises offsetting the second dimples laterally by one web relative to the first dimples.

20. The method of claim 16, in combination with a method of cooling the automatic transmission fluid, the method of cooling comprising:
heat exchanger of claim 1, wherein the first and second dimples are formed substantially centrally relative to the corresponding webs;
immersing at least the plurality of aluminum extruded tubes in a cooling liquid; and
routing the automatic transmission fluid through the plurality of aluminum extended tubes.
